(19) United States
(12) Patent Application Publication
(10) Pub. No.: US 2024/0145191 A1
(43) Pub. Date: May 2, 2024

(54) BISTABLE SWITCH INTENDED TO BE FITTED IN AN AIRCRAFT

(71) Applicant: SAFRAN ELECTRONICS & DEFENSE COCKPIT SOLUTIONS, MONTREUIL (FR)

(72) Inventor: Hector Morinet, Moissy-Cramayel (FR)

(73) Assignee: SAFRAN ELECTRONICS & DEFENSE, Paris (FR)

(21) Appl. No.: 18/278,165

(22) PCT Filed: Feb. 21, 2022
(86) PCT No.: PCT/FR2022/050301

§ 371 Date: Aug. 21, 2023

(30) Foreign Application Priority Data
Feb. 26, 2021 (FR) FR2101923

(51) Int. Cl. H01H 21/30; H01H 21/04; H01H 21/36

(52) U.S. Cl. CPC H01H 21/30; H01H 21/04; H01H 21/36

(57) ABSTRACT

This bistable switch (24) is intended to be fitted in an aircraft and comprises a frame (26) and a control means (34, 94) which is intended to be operated by a user, the control means (34, 94) being movable relative to the frame (26) between a first control position and a second control position. This switch (24) comprises a leaf spring (52) which is mechanically connected to the frame (26) and to the control means (34, 94), the leaf spring (52) being arranged in a buckling state and being configured to switch between the two control positions in each of its two stable buckling positions, respectively.

The present invention relates to a bistable switch, and more particularly to a switch intended to be fitted in an aircraft, in particular within the control or monitoring systems of such an aircraft.

Most aircraft comprise a large number of switches. For example, aircraft may comprise a bi-stable toggle switch, as is frequently the case in landing gear controls. Aircraft can also comprise a rotary bistable switch, for example for manoeuvre prohibition switches.

A function provided by a bistable switch consists in having two stable positions corresponding to the two control positions of the switch. For example, in the case of a landing gear extension control, a stable position corresponds to the “extended landing gear” position and a stable position corresponds to the “retracted landing gear” control. In particular, the function of the bistable switch is to avoid the existence of a third position of stable equilibrium which would harm the reliability of the control.

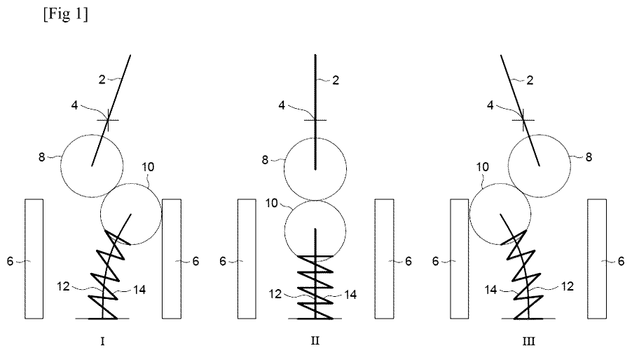

In this respect, a bistable switch known from the prior art, schematically illustrated in FIG. 1, can comprise a control lever 2 capable of pivoting about an axis 4 relative to a terminal 6. A lower end of the lever 2 is coupled to a first roller 8 in point or linear contact with a second roller 10. These two rollers are free to rotate. A flexible rod 12 is fixed by its lower end to a frame integral with the terminals 6. The roller 10 is slidably mounted on the rod 12. A spring 14 acting in compression maintains the roller 10 at the upper end of the rod 12 and in point or linear contact with the roller 8.

When this mechanism is in position I, the roller 10 is pressed by the spring 14 between a wall of the terminal 6 and the roller 8. Under these conditions, the roller 10 is in a position of stable equilibrium. In other words, position I is a position of stable equilibrium of the control lever 2.

When a user operates the control lever 2, he pivots the latter counter-clockwise and the mechanism is in the intermediate position II. In this position, the spring 14 pushes the roller 10 against the roller 8 and the forces exerted on the roller 10 are directed vertically and cancel each other out. In this way, the roller 10 is in an equilibrium position. However, a disturbance, for example a rotation of the control lever 2, tends to move the roller 10 away from the equilibrium position II. In other words, position II is a position of unstable equilibrium of the control lever 2.

In position III, the rollers 8 and 10 and the control lever 2 are symmetrical to the position I, relative to the vertical plane containing the axis 4. As a result, the roller 10 is stable between the spring 14, the terminal 6 and the roller 8. Position III is a position of stable equilibrium of the control lever 2.

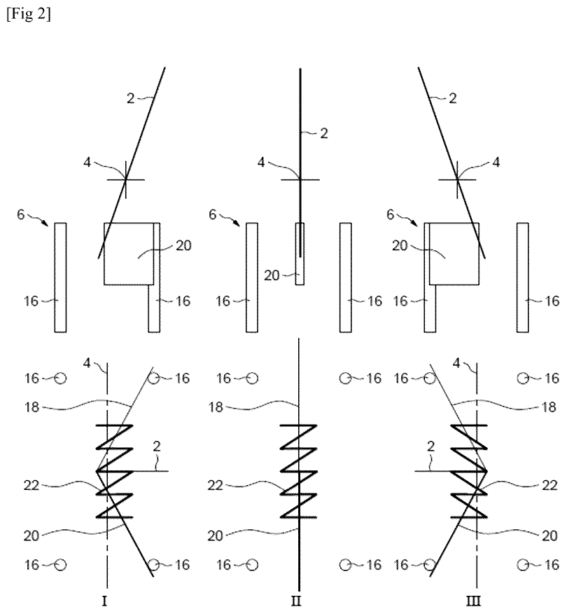

FIG. 2 schematically illustrates a second example of a mechanism fitted in a switch. As in the case of FIG. 1, three positions I, II and III are illustrated in FIG. 2, the mechanism being for each position illustrated in front view and in top view. Identical elements bear the same references.

In the example of FIG. 2, the terminal 6 comprises four pillars 16 distributed in a rectangular manner. The lower end of the lever 2 is attached to two tabs 18 and 20 which are rigid and capable of pivoting around a vertical axis. A spring 22 acting in traction tends to bring the opposite ends of the tabs 18 and 20 closer together.

When the mechanism is in position I, the tabs 18 and 20 are in linear contact with the two pillars 16 located on the right (compared to the views of FIG. 2). The spring 22 tends to reduce the angle between the tabs 18 and 20 and thereby presses the tabs 18 and 20 onto respective pillars 16. Therefore, the tabs 18 and 20 are in a stable position. In other words, position I is a position of stable equilibrium of the control lever 2.

The position II is an intermediate position wherein the control lever 2 is vertical. In this position, the tabs 18 and 20 have pivoted and are oriented in the same direction perpendicular to the axis 4. In this position, the tensile force exerted by the spring 22 is oriented in the direction of the tabs 18 and 20. It follows that the spring 22 does not modify the position of the tabs 18 and 20. The tabs 18 and 20 are then in an equilibrium position. However, a disturbance, for example in the form of a rotation of the control lever 2, modifies this state and tends to move the tabs 18 and 20 away from the equilibrium position. In other words, position II is a position of unstable equilibrium of the control lever 2.

In position III, the tabs 18 and 20 and the control lever 2 are symmetrical to the position I, relative to the vertical plane containing the axis 4. As a result, the tabs 18 and 20 are maintained in linear contact against the pillars 16 located on the left (compared to the views of FIG. 2) by the spring 22. Position III is a position of stable equilibrium of the control lever 2.

The two examples which have been described above therefore allow to obtain a switch having only two positions of stable equilibrium and are, for this reason, considered to be generally satisfactory.

However, the mechanical connections between the parts result in wear which can generate an additional stable equilibrium position. In the example of FIG. 1, a deformation of the rollers 8 and 10 can transform the point or linear contact connection into a flat support and transform position II into a position of stable equilibrium. In the example of FIG. 2, friction against the pivoting of the tabs 18 and 20 can also transform the position II into a position of stable equilibrium. This results in less reliable switching, in both cases.

In particular, an additional position of stable equilibrium is likely to appear when the forces exerted on the various mechanical parts are located in the same direction.

The invention aims at overcoming the aforementioned disadvantages.

More particularly, the invention aims at providing a bistable switch with improved switching reliability.

To this end, a bistable switch intended to be fitted in an aircraft is proposed, comprising a frame, at least one detection means and a control means which is intended to be operated by a user, the control means being movable relative to the frame between a first control position and a second control position.

According to one of its general features, this switch comprises a leaf spring which is mechanically connected to the frame and to the control means, the leaf spring being arranged in a buckling state and being configured to achieve adopt a first stable buckling position when the control means is in the first control position and to adopt a second stable buckling position when the control means is in the second control position, the at least one detection means being configured to detect the current control position and to emit a electrical control signal.

Such a switch allows to avoid the appearance of forces directed along the same axis. This results in the absence of an intermediate equilibrium position, which improves the reliability of the switching.

Preferably, the leaf spring has a thickness comprised between 0.05 mm and 0.25 mm.

Such a feature allows to obtain a snapping sound when moving from one buckling position to another, which improves the feeling of the user.

In one embodiment, the switch may comprise at least one electrical contact surface integral with the frame forming the detection means, the leaf spring being made of an electrically conductive material, the switch comprising means for causing electric current to flow through the leaf spring, the leaf spring being arranged such that it is in electrical contact with an electrical contact surface only in at least one of its two stable buckling positions.

Such an arrangement is advantageous insofar as it reduces the size and mass of the switch.

It is also possible to provide a rocker arm and at least one button forming a detection means, the rocker arm being capable of pivoting relative to the frame, and being mechanically connected to the leaf spring so as to form a kinematic chain with the leaf spring and the frame, the rocker arm moving from a first position when the leaf spring is in a buckling position to a second position when the leaf spring is in the other buckling position.

The addition of a rocker arm arranged in this way improves the precision and the repeatability of the behaviour of the switch, which allows to facilitate its dimensioning.

Preferably, the leaf spring comprises a proximal end portion relative to the control means and a distal end portion relative to the control means, the rocker arm comprising a rectilinear portion and a cavity delimited by the rectilinear portion, the cavity being adapted to receive the distal end portion.

Such an arrangement allows to implement the mechanical connection between the rocker arm and the leaf spring in a simple and reliable manner.

In one embodiment, the rocker arm comprises two lateral extensions extending in the same direction perpendicular to the rectilinear portion and intended to activate at least one button.

Such extensions combined with the detection means allow to detect even more reliably a buckling position of the leaf spring.

Preferably, the frame comprises a surface parallel to an axis of rotation of the rocker arm relative to the frame, a button being able to detect the proximity or the direct contact of a lateral extension of the rocker arm with the parallel surface.

It is possible, in this way, to detect in a particularly simple manner a position of the rocker arm relative to the frame so as to determine the buckling position of the leaf spring.

In one embodiment, the control means comprises a control lever capable of pivoting relative to the frame around a direction perpendicular to the plane of flexion of the leaf spring.

In another embodiment, the control means comprises a first part capable of pivoting relative to the frame around a direction perpendicular to the direction of flexion of the leaf spring. The switch comprises a second part movable in translation relative to the frame and interposed between the first part and the leaf spring, the first part (94) and the second part (100) being configured to transform a rotational movement of the first part relative to the frame into a translational movement of the second part relative to the frame.

A rotary switch having the above advantages is thus provided. In addition, such an arrangement allows to achieve the mechanical connection between the first part and the leaf spring in a simple manner, in the case of a rotary switch.

Other purposes, features and advantages of the invention will appear upon reading the following description, given only by way of non-limiting example, and made with reference to the appended drawings wherein:

FIG. 1

and

FIG. 2 to which reference has already been made, schematically illustrate prior art switch examples,

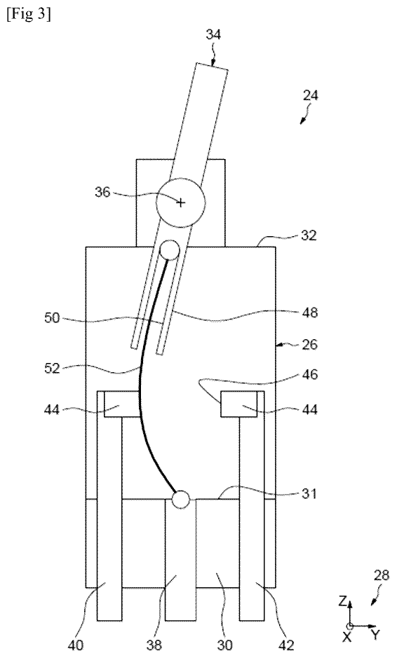

FIG. 3 illustrates a first position of stable equilibrium of a switch according to a first embodiment of the invention,

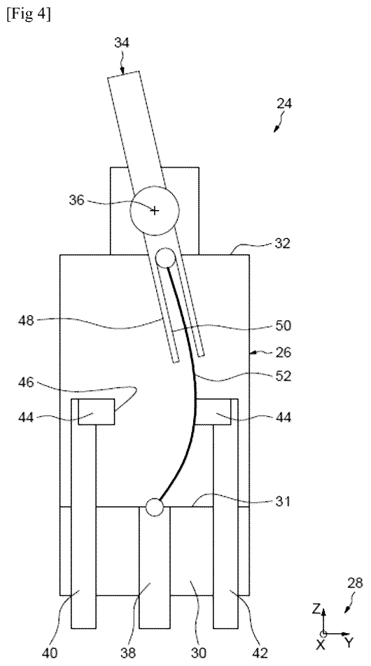

FIG. 4 schematically illustrates a second position of stable equilibrium of the switch of FIG. 3,

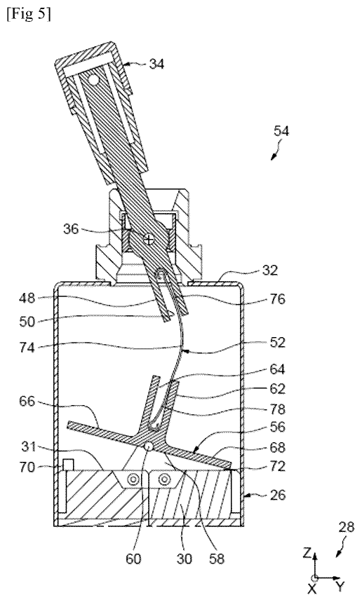

FIG. 5 schematically illustrates a first position of stable equilibrium of a switch according to a second embodiment of the invention,

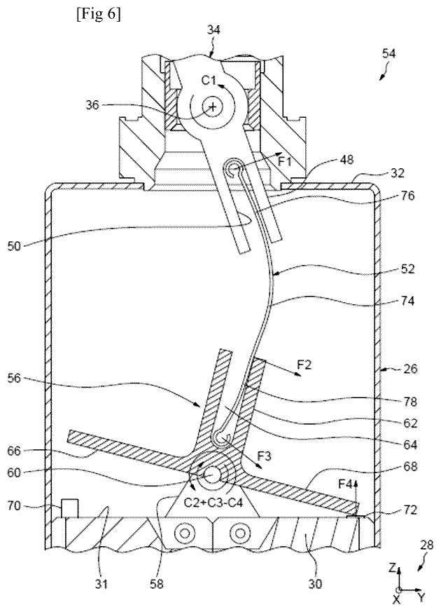

FIG. 6 is a detail view of the switch in FIG. 5,

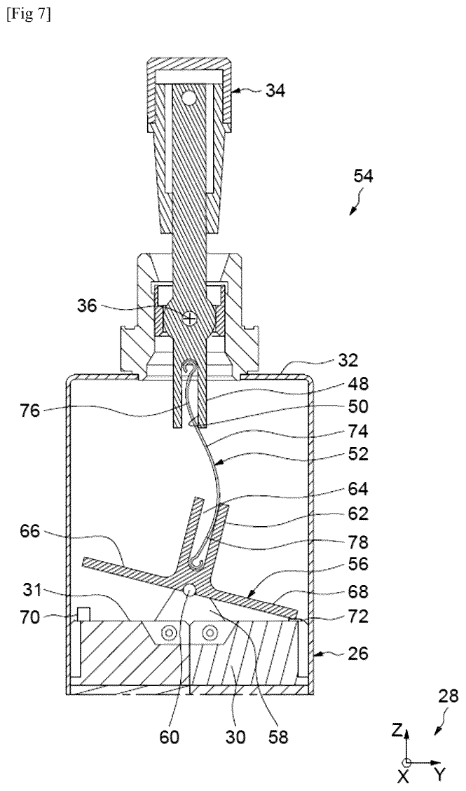

FIG. 7 schematically illustrates an intermediate position of the switch of FIGS. 5 and 6,

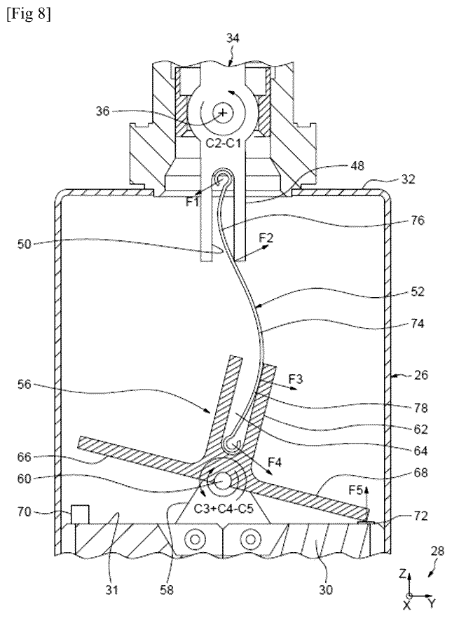

FIG. 8 is a detail view of the switch in the position of FIG. 7,

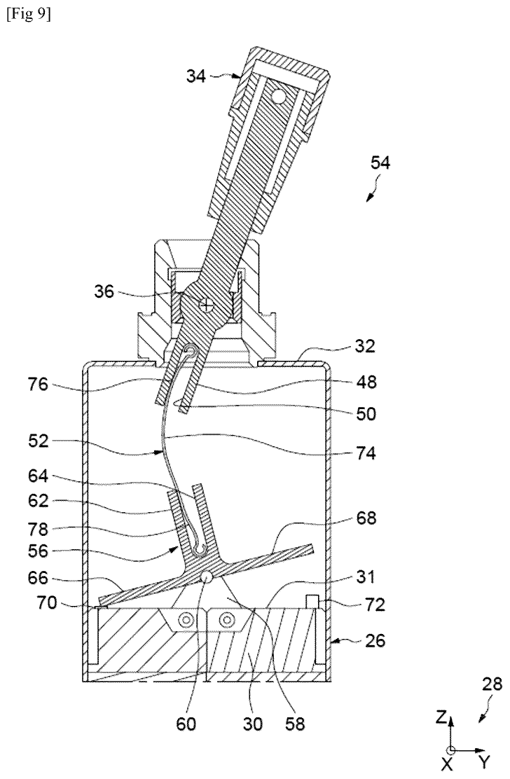

FIG. 9 schematically illustrates a second position of stable equilibrium of the switch of FIGS. 5 to 8,

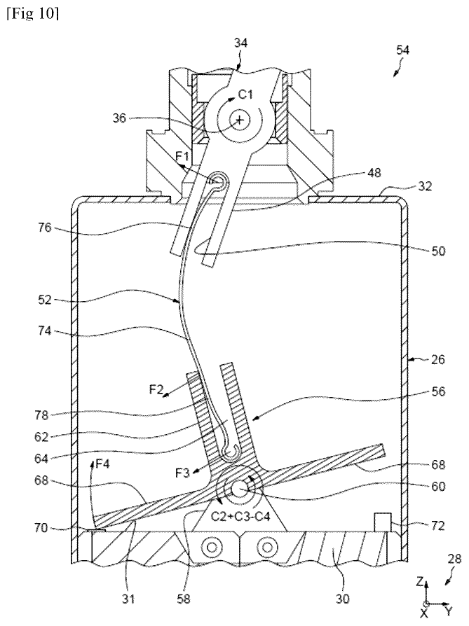

FIG. 10 is a detail view of the switch in the position of FIG. 9,

FIG. 11

and

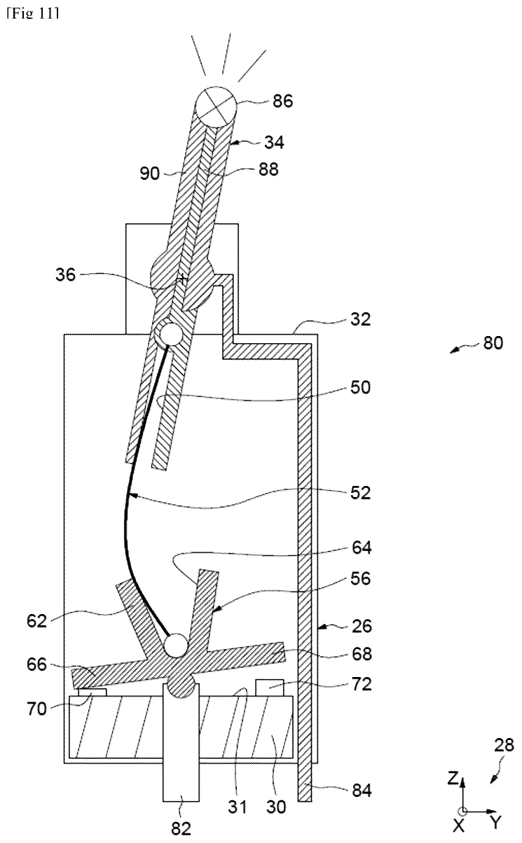

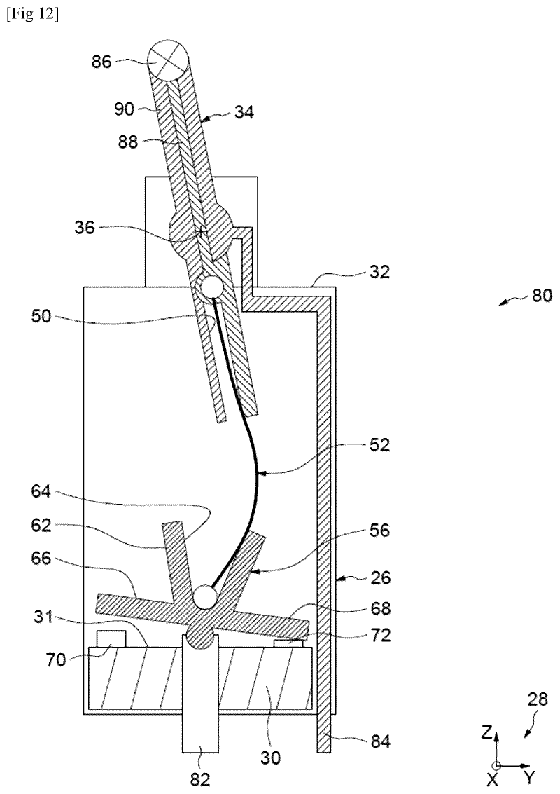

FIG. 12 schematically illustrate two positions of stable equilibrium of a switch according to a third embodiment,

FIG. 13 is a front view schematically illustrating a first position of stable equilibrium of a switch according to a fourth embodiment of the invention,

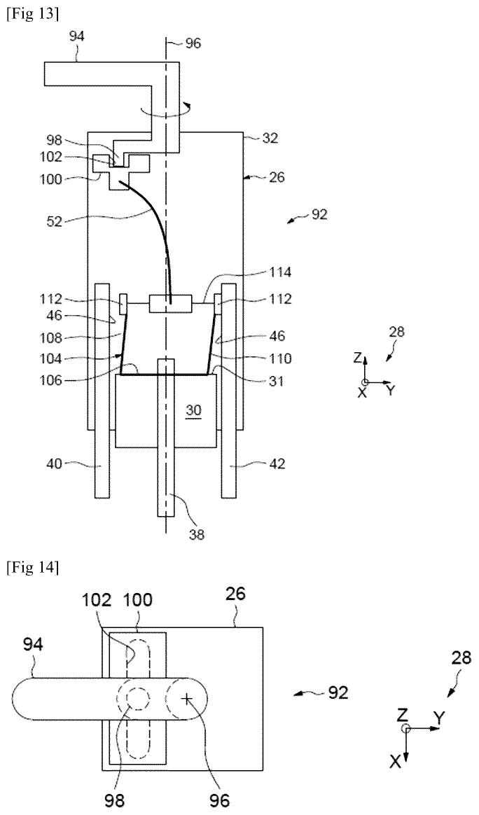

FIG. 14 is a top view of the switch in the equilibrium position of FIG. 13,

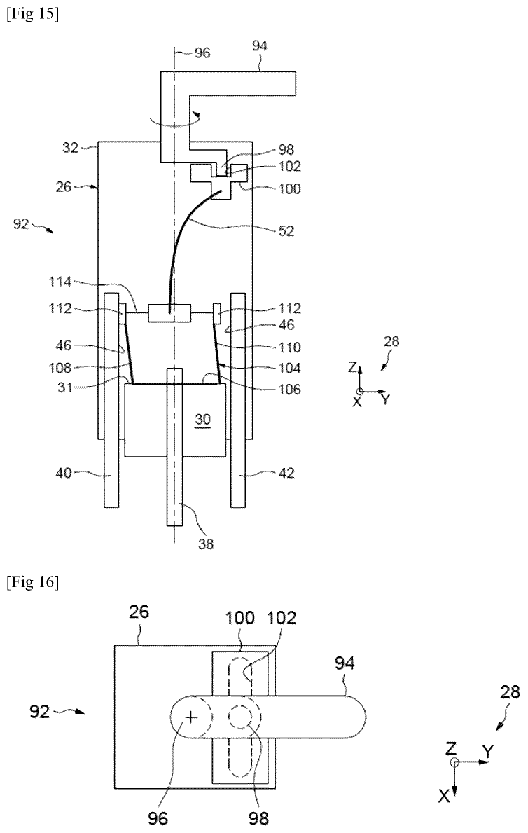

FIG. 15 is a front view schematically illustrating a second position of stable equilibrium of the switch of FIGS. 13 and 14, and

FIG. 16 is a top view of the switch in the position of FIG. 15.

With reference to FIG. 3, a bi-stable toggle switch 24 is schematically shown according to a first embodiment of the invention. The switch 24 is intended to be fitted in an aircraft cockpit. In this example, the switch 24 is an aircraft landing gear extension switch.

The switch 24 in particular includes a frame 26. A direct orthonormal vector base 28 attached to the frame 26 is defined. The vector base 28 consists of a vector X, a vector Y and a vector Z. In the present application, the terms “lower”, “upper”, “vertical”, “horizontal”, “high”, “low”, “below”, “above” and their derivatives shall be understood to refer to the direction and to the sense of the vector Z when the frame 26 is normally placed on a flat horizontal surface, that is to say when the vector Z is vertical and directed upwards.

The frame 26 includes a base 30 and an armature 32. The base 30 includes an upper surface 31 perpendicular to the vector Z.

The switch 24 includes a control lever 34 which is intended to be operated by a user, in this case a pilot of the aircraft. The control lever 34 is mechanically connected to the armature 32 so as to be able to pivot, relative to the frame 26, around an axis 36 parallel to the vector X. In this way, the control lever 34 is movable between a first control position illustrated in FIG. 3 and a second control position illustrated in FIG. 4.

The frame 26 includes three electrically conductive paths 38, 40 and 42 which are vertical and arranged respectively in the middle and on each side of the base 30. The path 38 extends to the upper surface 31. The paths 40 and 42 are longer and extend vertically projecting through the upper surface 31 then to halfway between the base 30 and the axis 36. The paths 40 and 42 each comprise a horizontal protrusion 44 extending in the direction of the central path 38. The protrusion 44 ends in a vertical surface 46. The protrusion 44 and the surface 46 are made of an electrically conductive material, preferably the same as that used to form the electrically conductive paths 38, 40 and 42.

The control lever 34 includes a lower portion 48 located below the axis 36. The portion 48 includes a rectilinear groove 50 extending in the longitudinal direction of the portion 48 from a lower front surface of the portion 48.

The switch 24 includes a leaf spring 52. The leaf spring 52 is mechanically pivotally connected to the base 30 and mechanically pivotally connected to the lower portion 48. In the example shown, the leaf spring 52 is electrically connected with the electrically conductive path 38.

In the example illustrated, a lower end of the leaf spring 52 may be welded to the conductive path 38. An upper end of the leaf spring 52 may be inserted into the groove 50.

In the example illustrated, the leaf spring 52 has a thickness comprised between 0.05 mm and 0.25 mm, preferably between 0.1 mm and 0.2 mm. Such a thickness of the leaf spring 52 allows to obtain flexibility avoiding premature fatigue of the leaf spring 52 and to obtain a snapping sound when moving from one buckling position to another buckling position. The leaf spring 52 is, in the example shown, made from stainless steel. Stainless steel is preferably cold rolled for work hardening and, spring rolled, C1300 or C1700. Due to the choice of a stainless steel and its mechanical and electrical connection with the conductive path 38, electric current can flow through the spring 52.

As shown in FIGS. 3 and 4, the leaf spring 52 is arranged in a buckling state. A buckling state corresponds to a state of compression of the leaf spring 52 along its length beyond a predefined buckling limit value resulting in a transverse deformation, along its thickness. A buckling position corresponds to a position taken by the leaf spring 52 during its buckling, on one side or the other of a median plane. In this case, the median plane is perpendicular to the vector Y and contains the axis 36. The flexion of the leaf spring 52 occurs in a plane perpendicular to the vector X.

In the position illustrated in FIG. 3, the leaf spring 52 is compressed by the base 30 at its lower end and by the portion 48 at its upper end, so that it tends to buckle even more. In this position, the leaf spring 52 is in contact against the surface 46 of the protrusion 44 of the path 40. As a result, the mechanical connections acting on the leaf spring 52 are isostatic and the leaf spring 52 is in an equilibrium position. A disturbance of the equilibrium position, for example a slight rotation of the lever 34 counter-clockwise tends to eliminate the contact between the leaf spring 52 and the surface 46 of the protrusion 44 of the path 40. This results in the disappearance of the force tending to prevent the buckling of the leaf spring 52 towards the conductive path 40. Thus, a disturbance of the equilibrium position tends to bring the leaf spring 52 closer to the aforementioned equilibrium position. It follows that the position shown in FIG. 3 is a position of stable equilibrium of the lever 34.

In this position, the contact between the leaf spring 52 and the surface 46 allows electric current to flow from the leaf spring 52 to the conductive path 40. This results in the electrical connection between the conductive paths 38 and 40.

The position illustrated in FIG. 4 is symmetrical, relative to the median plane, to the position illustrated in FIG. 3. For the same reasons, this position is a position of stable equilibrium of the control lever 34.

In this position, the contact between the leaf spring 52 and the surface 46 of the protrusion 44 of the path 42 allows electrical current to flow from the leaf spring 52 to the path 42. This results in the electrical connection of the conductor paths 38 and 42.

Thus, in the example illustrated, a switch is provided having two positions of stable equilibrium and allowing, respectively, to electrically connect the conductive path 38 to the conductive paths 40 and 42. In other words, when the control lever 34 is switched from one control position to the other, the leaf spring 52 moves from one buckling position to the other so that either of the electrically conductive paths 40, 42 is connected with the central electrically conductive path 38 via the protrusions 44 and the leaf spring 52. It is thus possible to control the retraction or extension of a landing gear of the aircraft.

It is also possible for the leaf spring to be in electrical contact with an electrical contact surface in the two stable buckling positions, the switch delivering an “open” signal in one position and a “closed” signal in the other position.

Without departing from the scope of the invention, it is possible to consider one of the paths 40 and 42 being electrically insulating. In this case, one of the positions of stable equilibrium of the control lever 34 electrically connects the two electrically conductive paths, while the other position of stable equilibrium disconnects them.

With reference to FIGS. 5 to 10, a switch 54 is schematically shown according to a second embodiment of the invention. Identical elements bear the same references.

The switch 54 differs from the switch 24 in that it lacks conductive paths 38, 40 and 42. Instead, the switch is provided with two-button detection means 70, allowing to emit an electrical signal when pressing on their surface.

The base 30 includes a surface 34 on which an insert 58 is fixed, the two buttons 70 and 72 being arranged on the surface 31 on either side of the insert 58.

The switch 54 includes a rocker arm 56 mounted to pivot relative to the insert 58 around an axis 60. The axis 60 is parallel to the vector X. The axis 60 is located in the median plane perpendicular to the vector Y and containing the axis 36. The axis 60 is vertically offset upwards relative to the upper surface 31, by a vertical offset Δ₆₀. The offset Δ₆₀ and the length of the lateral extension 68 result in the angle of incidence allowing to estimate the compression force applied to the two buttons 70 and 72. In other words, the offset Δ₆₀, the length of the lateral extensions 68 and of the rectilinear portion 62 are determined according to the minimum force required to operate a button 70, 72 and according to the length of the leaf spring 52 used.

The rocker arm 56 comprises a rectilinear portion 62 provided with a cavity 64 forming a rectilinear groove. The rocker arm 56 includes a lateral extension 66 and a lateral extension 68. The lateral extensions 66 and 68 extend respectively on either side of the rectilinear portion 62, perpendicular to the rectilinear portion 62. The extensions 66 and 68 have a same length l₆₆₆₈,

In this way, the rocker arm 56 is able to pivot about the axis 60, relative to the frame 26, between a position wherein the end of the extension 66 is in contact with the surface 31, and a position wherein the end of the extension 68 is in contact with the surface 31.

The buttons 70 and 72 then detect the proximity of the respective lateral extensions 66 and 68 with the surface 31.

The leaf spring 52 includes a central portion 74, an upper portion 76 and a lower portion 78. The upper portion 76 is received in the groove 50 of the portion 48 of the control lever 34. The lower portion 78 is received in the cavity 64 of the rocker arm 56. The portions 76 and 78 may comprise ends forming a winding to facilitate their reception in the groove 50 and the cavity 64, respectively. As a result, a kinematic chain is produced between, in succession, the control lever 34, the leaf spring 52, the rocker arm 56 and the frame 26. In this kinematic chain, a mechanical pivot connection is produced between the control lever 34 and the leaf spring 52 and a mechanical pivot connection is produced between the leaf spring 52 and the rocker arm 56.

In the position illustrated in FIGS. 5 and 6, the leaf spring 52 is in a buckling state towards the button 72. As a result, the end of the extension 68 is contacted against the button 72. When this occurs, it is no longer possible to pivot the rocker arm 56 clockwise and the spring 52 is in a position of stable equilibrium. More particularly, with reference to FIG. 6, the upper end of the leaf spring 52 exerts a force F1 on the portion 48 of the control lever 34, which causes a torque C1 around the axis 36. The boundary zone between the central portion 74 and the lower portion 78 of the leaf spring 52 exerts a force F2 on an upper end of the rectilinear portion 62 of the rocker arm 56. A lower end of the leaf spring 52 exerts a force F3 on the rectilinear portion 62 of the rocker arm 56. The forces F2 and F3 generate a torque C2+C3 around the axis 60. The button 72 exerts a vertical force F4 on the end of the extension 68, which results in a torque C4 opposite to the torque C2+C3.

As a result, the rocker arm 56 is in a position of stable equilibrium of contact with the button 72 and a torque tends to oppose a clockwise rotation of the control lever 34.

FIG. 8 illustrates an intermediate position between the positions of FIGS. 5 and 9. In this position, an upper end of the leaf spring 52 exerts a force F1 on the portion 48 of the control lever 34, and the boundary zone between the central portion 74 and the upper portion 76 exerts a force F2 on a lower end of the portion 48 of the control lever 34. This results in a counter-clockwise torque C2−C1 around the axis 36. A boundary zone between the central portion 74 and the lower portion 78 exerts a force F3 on an upper end of the rectilinear portion 62 of the rocker arm 56, and a lower end of the leaf spring 52 exerts a force F4 on the rectilinear portion 62 of the rocker arm 56. This results in a clockwise torque C3+C4 around the axis 60. The torque C3+C4 tends to bring the end of the extension 68 closer to the upper surface 31. As a result, the button 72 exerts a vertical force F5 against the end of the extension 68, which results in a counter-clockwise torque C5 around the axis 60.

In the intermediate position, the appearance of forces directed along non-vertical directions generates totally different torques on the control lever 34 and on the rocker arm 56. This results in the very low probability of finding an equilibrium position apart from positions of FIGS. 5 and 9 and, in the event that such an equilibrium position is found, the strong instability of this equilibrium position.

FIGS. 9 and 10 schematically illustrate the switch 54 in another position of stable equilibrium. This position of stable equilibrium is symmetrical, relative to the median plane, at the stable equilibrium pressure of FIGS. 5 and 6. In this equilibrium position, the leaf spring 52 is in a state of buckling in the direction of the button 70. As a result, the end of the extension 66 is contacted against the button 70. With reference to FIG. 10, the upper end of the leaf spring 52 exerts a force F1 which causes a torque C1 around the axis 36. The boundary zone between the central portion 74 and the lower portion 78 of the leaf spring 52 exerts a force F2. The lower end of the leaf spring 52 exerts a force F3. The forces F2 and F3 generate a torque C2+C3 around the axis 60. The button 70 exerts a vertical force F4, which results in a torque C4 opposite to the torque C2+C3.

As a result, the rocker arm 56 is in a position of stable equilibrium of contact with the button 70 and a torque tends to oppose a counter-clockwise rotation of the control lever 34.

FIGS. 11 and 12 illustrate two positions of stable equilibrium of a switch 80 according to a third embodiment of the invention. Identical elements bear the same references.

The switch 80 differs from the switch 54 in that the frame 26 includes two electrically conductive paths 82 and 84. The path 82 passes through the base 30 until the upper surface 31 is in electrical contact with the rocker arm 56. The rocker arm 56 is made of an electrically conductive material, which allows to establish an electrical connection between the path 82 and the leaf spring 52. The path 84 passes through the base 30, extends along the armature 32, then passes from the armature 32 to the control lever 34.

The switch 80 further differs from the switch 54 in that the control lever 34 includes a light emitting diode 86 on its upper end. The path 84 is electrically connected to one terminal of the light emitting diode 86.

The switch 80 further differs from the switch 56 in that the control lever 34 includes an electrically insulating path 88 and an electrically conductive path 90. As illustrated in FIGS. 11 and 12, the electrically insulating path 88 is interposed between the portion of the electrically conductive path 84 located on the control lever 34 and the electrically conductive path 90. More particularly, relative to FIGS. 11 and 12, a slice located to the right of the thickness of the control lever 34 and above the axis 36 comprises the electrically conductive path 84, a central slice of the control lever 34 and the portion located to the right of the groove 50 comprises the electrically insulating path 88 and a slice located to the left of the control lever 34 and the portion located to the left of the groove 50 comprises the electrically conductive path 90. A second terminal of the light emitting diode 86 is electrically connected to the electrically conductive path 90.

As a result, when the control lever 34 is in the position of stable equilibrium illustrated in FIG. 11, the leaf spring 52 is in contact with the electrically conductive path 90. This results in the electrical connection between the paths 82 and 90. As a result, both terminals of the light-emitting diode are supplied with electricity, and the light-emitting diode 86 is turned on.

In the equilibrium position of FIG. 12, the leaf spring 52 is in contact with the electrically insulating path 88. This results in the absence of an electrical connection between the path 82 and the light-emitting diode 86. As a result, only one terminal of the light-emitting diode 86 is supplied with electrical energy and the light-emitting diode 86 is turned off.

In the examples of FIGS. 11 and 12, the switching is implemented by means of the buttons 70 and 72. However, without departing from the scope of the invention, it is possible to consider switching by a contact between the leaf spring 52 and an electrically conductive vertical surface, as in the example of FIGS. 3 and 4.

FIGS. 13, 14, 15 and 16 schematically illustrate positions of stable equilibrium of a rotary switch 92 according to a fourth embodiment of the invention. Identical elements bear the same references.

The switch 92 differs from the switch 24 of FIGS. 3 and 4 in that the vertical surfaces 46 form part of the electrically conductive paths 40 and 42.

The switch 92 further differs from the switch 24 in that it lacks the control lever 34. Instead, the switch 92 includes a rotary button 94 capable of pivoting, relative to the frame 26, about an axis 96 parallel to the vector Z. The rotary button 94 includes a finger 98 eccentric relative to the axis 96.

The switch 92 further differs from the switch 24 in that it includes an intermediate part 100. The intermediate part 100 is mechanically connected to an upper end of the leaf spring 52 by a mechanical pivot connection. The intermediate part 100 includes a rectilinear groove 102 receiving the finger 98. The intermediate part 100 is fixed to the frame by means of a sliding connection allowing movement of the intermediate part 100 in a direction perpendicular to the rectilinear groove 102. In this way, the finger 98, the rectilinear groove 102 and the sliding connection allow to transform a rotational movement of the button 94 around the axis 96 into a translational movement of the intermediate part 100 in the direction of the vector Y.

The switch 92 further differs from the switch 24 in that it includes a rocker arm 104. The rocker arm 104 includes a base 106 integral with the upper surface 31. The rocker arm 104 includes two beams 108 and 110 mechanically connected to two respective sides of the base 106. The beams 108 and 110 are substantially parallel. The beams 108 and 110 are capable of pivoting relative to the base 106 around a direction parallel to the vector X. The beams 108 and 110 are connected to two upper end protrusions 112 capable of being in contact with the respective vertical surfaces 46. The protrusions 112 are connected by an upper beam 114. A lower end of the leaf spring 52 is mechanically connected by a mechanical pivot connection to the upper beam 114. The base 106 and the beams 108 and 110 are made of an electrically conductive material, preferably the same material as that used to form the electrically conductive paths 38, 40 and 42.

With reference to FIGS. 13 and 14, the rotary button 94 is in a position such that the intermediate part 100 is positioned above the electrically conductive path 40. This results in a buckling of the leaf spring 52 in the direction of the electrically conductive path 42. Under these conditions, the lower end of the spring 52 exerts a force tending to move the upper beam 114 towards the electrically conductive path 42. This results in contact between the protrusion 112 of the beam 110 and the electrically conductive path 42. A disturbance, for example a rotation of the button 94, removes the contact between the protrusion 112 and the path 42, which tends to move the beam 114 again in the direction of the path 42. As a result, the rocker arm 104 and the rotary button 94 are in a position of stable equilibrium.

In this position, the contact between the protrusion 112 and the path 42 electrically connects the paths 38 and 42.

In the position illustrated in FIG. 15, the rotary button 94 is in an opposite angular position relative to the position of FIGS. 13 and 14 and the intermediate part 100 is located above the path 42. As a result, the leaf spring 52 buckles in the direction of the path 40. This results in a movement of the beam 114 in the direction of the path 40 and the protrusion 112 of the beam 108 is in stable contact against the path 40. As a result, the rotary button 94 is in a position of stable equilibrium and the paths 38 and 40 are electrically connected.

In this example, the electrical connection is implemented by means of a contact between the rocker arm 104 and the surfaces 46. However, without departing from the scope of the invention, it is possible to consider implementing the electrical connection by means of direct contact between the spring 52 and the surfaces 46 as in the first embodiment, or else to provide buttons such as the buttons 70 and 72 of the second and third embodiments.

The embodiments of the switches according to the invention thus allow to improve the reliability of the switching by providing two and only two positions of stable equilibrium and by exerting forces resisting tilting which are proportional to the curvature and the stiffness of the leaf spring 52. Furthermore, the embodiments which have been described allow to obtain these results by using a smaller number of parts than in the solutions of the prior art, which further improves the reliability of the mechanism and reduces its manufacturing cost.

1. A bistable switch for an aircraft, the bistable switch comprising:
a frame and a control means which is intended to be operated by a user, the control means being movable relative to the frame between a first control position and a second control position,
characterised in the bistable switch further comprises a leaf spring which is mechanically connected to the frame and to the control means, the leaf spring being arranged in a buckling state and being configured to adopt a first stable buckling position when the control means is in the first control position and to adopt a second stable buckling position when the control means is in the second control position and to switch in each of the two first and second buckling positions,
the control means comprising a first part capable of pivoting relative to the frame around a direction perpendicular to the direction of flexion of the leaf spring,
the switch comprising a second part movable in translation relative to the frame and interposed between the first part and the leaf spring, the second part including a rectilinear groove, the second part being fixed to the frame by means of a sliding connection allowing movement of the second part in a direction perpendicular to the rectilinear groove,
the first part and the second part being configured to transform a rotational movement of the first part relative to the frame into a translational movement of the second part relative to the frame, the first buckling position and the second buckling position are arranged symmetrically relative to the axis of rotation of the control means.

2. The switch according to claim 1, wherein the leaf spring has a thickness comprised between 0.05 mm and 0.25 mm.

3. The switch according to claim 1, comprising at least one electrical contact surface integral with the frame, the leaf spring being made of an electrically conductive material, the switch comprising means for causing electric current to flow through the leaf spring, the leaf spring being arranged such that it is in electrical contact with an electrical contact surface in at least one of its two stable buckling positions.

4. The switch according to claim 1, further comprising a rocker arm and at least one detection button, the rocker arm being capable of pivoting relative to the frame and being mechanically connected to the leaf spring so as to form a kinematic chain with the leaf spring and the frame, the rocker arm moving from a first position when the leaf spring is in a buckling position to a second position when the leaf spring is in the other buckling position.

5. The switch according to claim 4, wherein the leaf spring comprises a proximal end portion relative to the control means and a distal end portion relative to the control means, the rocker arm comprising a rectilinear portion and a cavity delimited by the rectilinear portion, the cavity being adapted to receive the distal end portion.

6. The switch according to claim 5, wherein the rocker arm comprises two lateral extensions extending in the same direction perpendicular to the rectilinear portion, intended to activate at least one button.

7. The switch according to claim 6, wherein the frame comprises a surface parallel to an axis of rotation of the rocker arm relative to the frame, a button being able to detect the proximity or the direct contact of a lateral extension of the rocker arm with the parallel surface.
